(19) United States
(12) Patent Application Publication
(10) Pub. No.: US 2014/0156264 A1
(43) Pub. Date: Jun. 5, 2014

(54) OPEN LANGUAGE LEARNING FOR INFORMATION EXTRACTION

(71) Applicant: University of Washington through it Center for Commercialization, Seattle, WA (US)

(72) Inventors: Oren Etzioni, Seattle, WA (US); Robert E. Bart, Bellevue, WA (US); Mausam, Seattle, WA (US); Michael D. Schmitz, Langley, WA (US); Stephen G. Doderland, Bainbridge Island, WA (US)

(21) Appl. No.: 14/083,261

(22) Filed: Nov. 18, 2013

Related U.S. Application Data
(60) Provisional application No. 61/728,063, filed on Nov. 19, 2012.

(51) Int. Cl. G06F 17/27

(52) U.S. Cl. CPC G06F 17/2705
USPC 704/9

(57) ABSTRACT

A system for extracting relational tuples from sentences is provided. The system includes a bootstrapper, an open pattern learner, and a pattern matcher. The bootstrapper generates training data by, for each of a plurality of seed tuples, identifying sentences of a corpus that contains the words of the seed tuple. The open pattern learner learns, from the seed tuples and sentence pairs, open patterns that encode ways in which relational tuples may be expressed in a sentence, The pattern matcher matches the open patterns to a dependency parse of a sentence, identifies base nodes of the dependency parse for the arguments and relation for the relational tuple that the open pattern encodes, and expands the arguments and relation of the relational tuple.

### CROSS-REFERENCE TO RELATED APPLICATION

This application claims the benefit of U.S. Provisional Patent Application No. 61/728,063 filed Nov. 19, 2012, entitled “Open Language Learning for Information Extraction,” which is incorporated herein by reference in its entirety.

### STATEMENT OF GOVERNMENT INTEREST

This invention was made with government support under Grant No. FA8750-09-c-0179, awarded by the Defense Advanced Research Projects Agency (DARPA), Grant No. FA8650-10-7058, awarded by the Intelligence Advanced Research Projects Activity, Grant No. IIS-0803481, awarded by the National Science Foundation, and Grant No. N00014-08-1-0431 awarded by the Office of Naval Research (ONR). The government has certain rights in the invention.

### BACKGROUND

While traditional Information Extraction (IE) (ARPA, 1991; ARPA, 1998) focused on identifying and extracting specific relations of interest, there has been great interest in scaling IE to a broader set of relations and to far larger corpora (Banko et al., 2007; Hoffmann et al., 2010; Mintz et al., 2009; Carlson et al., 2010; Fader et al., 2011). However, the requirement of having pre-specified relations of interest is a significant obstacle. Imagine an intelligence analyst who recently acquired a terrorist's laptop or a news reader who wishes to keep abreast of important events. The substantial endeavor in analyzing their corpus is the discovery of important relations, which are likely not pre-specified. Open IE (Banko et al., 2007) is the state-of-the-art approach for such scenarios.

However, the state-of-the-art Open IE systems, REVERB (Fader et al., 2011; Etzioni et al., 2011) and WOE^{parse} (Wu and Weld, 2010) suffer from two key drawbacks. Firstly, they handle a limited subset of sentence constructions for expressing relationships. Both extract only relations that are mediated by verbs, and REVERB further restricts this to a subset of verbal patterns. This misses important information mediated via other syntactic entities such as nouns and adjectives, as well as a wider range of verbal structures (examples #1-3 in Table 1).

Secondly, REVERB and WOE^{parse} perform only a local analysis of a sentence, so they often extract relations that are not asserted as factual in the sentence (examples #4,5 in Table 1). This often occurs when the relation is within a belief, attribution, hypothetical or other conditional context.

TABLE 1

| | |
|---|---|
| 1. | “After winning the Superbowl, the Saints are now the top dogs |
| | of the NFL.” |
| | O: (the Saints; win; the Superbowl) |
| 2. | “There are plenty of taxis available at Bali airport.” |
| | O: (taxis; be available at; Bali airport) |
| 3. | “Microsoft co-founder Bill Gates spoke at ...” |
| | O: (Bill Gates; be co-founder of; Microsoft) |
| 4. | “Early astronomers believed that the earth is the center of the |
| | universe.” |
| | R: (the earth; be the center of; the universe) |
| | W: (the earth; be; the center of the universe) |
| | O: ((the earth; be the center of; the universe) |
| | AttributedTo believe; Early astronomers) |
| 5. | “If he wins five key states, Romney will be elected President.” |
| | R, W: (Romney; will be elected; President) |
| | O: ((Romney; will be elected; President) |
| | ClausalModifier if; he wins five key states) |

### BRIEF DESCRIPTION OF THE DRAWINGS

FIG. 1 illustrates OLLIE'S (Open Language Learning for Information Extraction) architecture for learning and applying binary extraction patterns.

FIG. 2 is a sample dependency parse.

FIG. 3 illustrates bootstrapping.

FIG. 4 illustrates open pattern learning.

FIG. 5 illustrates identifying candidate patterns.

FIG. 6 illustrates pattern matching.

FIG. 7 illustrates context analysis.

### DETAILED DESCRIPTION

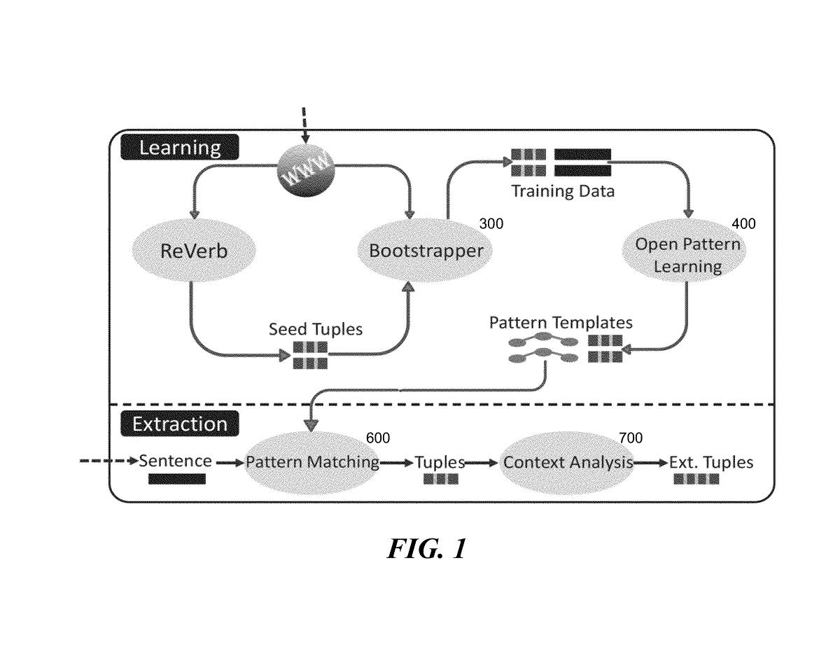

FIG. 1 illustrates OLLIE'S (Open Language Learning for Information Extraction) architecture for learning and applying binary extraction patterns. OLLIE begins with seed tuples from REVERB, uses them to build a bootstrap training set, and learns open pattern templates. These are applied to individual sentences at extraction time. First, it uses a set of high precision seed tuples from REVERB (200) to bootstrap a large training set (300). Second, it learns open pattern templates over this training set (400). Next, OLLIE applies these pattern templates at extraction time (600). This section describes these three steps in detail. Finally, OLLIE analyzes the context around the tuple to add information (attribution, clausal modifiers) and a confidence function (700).

Referring to Table 1, OLLIE (O) has a wider syntactic range and finds extractions for the first three sentences where REVERB (R) and WOE^{parse} (W) find none. For sentences #4,5, REVERB and WOE^{parse} have an incorrect extraction by ignoring the context that OLLIE explicitly represents.

Open IE systems extract tuples consisting of argument phrases from the input sentence and a phrase from the sentence that expresses a relation between the arguments, in the format (arg1; rel; arg2). This is done without a pre-specified set of relations and with no domain-specific knowledge engineering. We compare OLLIE to two state-of-the-art Open IE systems: (1) REVERB (Fader et al., 2011), which uses shallow syntactic processing to identify relation phrases that begin with a verb and occur between the argument phrases (Available for download at http://reverb.cs.washington.edu/); (2) WOE^{parse} (Wu and Weld, 2010), which uses bootstrapping from entries in Wikipedia info-boxes to learn extraction patterns in dependency parses. Like REVERB, the relation phrases begin with verbs, but can handle long-range dependencies and relation phrases that do not come between the arguments. Unlike REVERB, WOE does not include nouns within the relation phrases (e.g., cannot represent ‘is the president of’ relation phrase). Both systems ignore context around the extracted relations that may indicate whether it is a supposition or conditionally true rather than asserted as factual (see #4-5 in Table 1).

The task of Semantic role labeling is to identify arguments of verbs in a sentence, and then to classify the arguments by mapping the verb to a semantic frame and mapping the argument phrases to roles in that frame, such as agent, patient, instrument, or benefactive. SRL systems can also identify and classify arguments of relations that are mediated by nouns when trained on NomBank annotations. Where SRL begins with a verb or noun and then looks for arguments that play roles with respect to that verb or noun, Open IE looks for a phrase that expresses a relation between a pair of arguments. That phrase is often more than simply a single verb, such as the phrase ‘plays a role in’, or ‘is the CEO of’.

### 1. CONSTRUCTING A BOOTSTRAPPING SET (300)

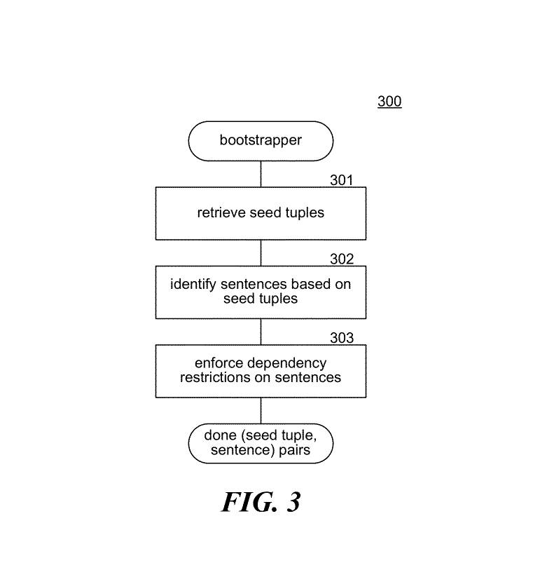

FIG. 3 illustrates bootstrapping. Our goal is to automatically create a large training set, which encapsulates the multitudes of ways in which information is expressed in text. The key observation is that almost every relation can also be expressed via a REVERB-style verb-based expression. So, bootstrapping sentences based on REVERB'S tuples will likely capture all relation expressions.

We start with over 110,000 seed tuples—these are high confidence REVERB extractions from a large Web corpus (ClueWeb) (http://lemurproject.org/clueweb09.php/) that are asserted at least twice and contain only proper nouns in the arguments (301). These restrictions reduce ambiguity while still covering a broad range of relations. For example, a seed tuple may be (Paul Annacone; is the coach of; Federer) that REVERB extracts from the sentence “Paul Annacone is the coach of Federer.”

For each seed tuple, we retrieve all sentences in a Web corpus that contains all content words in the tuple (302). We obtain a total of 18 million sentences. For our example, we will retrieve all sentences that contain ‘Federer’, ‘Paul’, ‘Annacone’ and some syntactic variation of ‘coach’. We may find sentences like “Now coached by Annacone, Federer is winning more titles than ever.”

Our bootstrapping hypothesis assumes that all these sentences express the information of the original seed tuple. This hypothesis is not always true. As an example, for a seed tuple (Boyle; is born in; Ireland) we may retrieve a sentence “Felix G. Wharton was born in Donegal, in the northwest of Ireland, a county where the Boyles did their schooling.”

To reduce bootstrapping errors we enforce additional dependency restrictions on the sentences (303). We only allow sentences where the content words from arguments and relation can be linked to each other via a linear path of size four in the dependency parse. To implement this restriction, we only use the subset of content words that are headwords in the parse tree. In the above sentence ‘Ireland’, ‘Boyle’ and ‘born’ connect via a dependency path of length six, and hence this sentence is rejected from the training set. This reduces our set to 4 million (seed tuple, sentence) pairs.

In our implementation, we use Malt Dependency Parser (Nivre and Nilsson, 2004) for dependency parsing, since it is fast and hence, easily applicable to a large corpus of sentences. We post-process the parses using Stanford's CCprocessed algorithm, which compacts the parse structure for easier extraction (de Marneffe et al., 2006).

We randomly sampled 100 sentences from our bootstrapping set and found that 90 of them satisfy our bootstrapping hypothesis (64 without dependency constraints). We find this quality to be satisfactory for our needs of learning general patterns.

Bootstrapped data has been previously used to generate positive training data for IE (Hoffmann et al., 2010; Mintz et al., 2009). However, previous systems retrieved sentences that only matched the two arguments, which is error-prone, since multiple relations can hold between a pair of entities (e.g., Bill Gates is the CEO of, a co-founder of, and has a high stake in Microsoft).

Alternatively, researchers have developed sophisticated probabilistic models to alleviate the effect of noisy data (Riedel et al., 2010; Hoffmann et al., 2011). In our case, by enforcing that a sentence additionally contains some syntactic form of the relation content words, our bootstrapping set is naturally much cleaner.

Moreover, this form of bootstrapping is better suited for Open IE's needs, as we will use this data to generalize to other unseen relations. Since the relation words in the sentence and seed match, we can learn general pattern templates that may apply to other relations too. We discuss this process next.

### 2. OPEN PATTERN LEARNING (400)

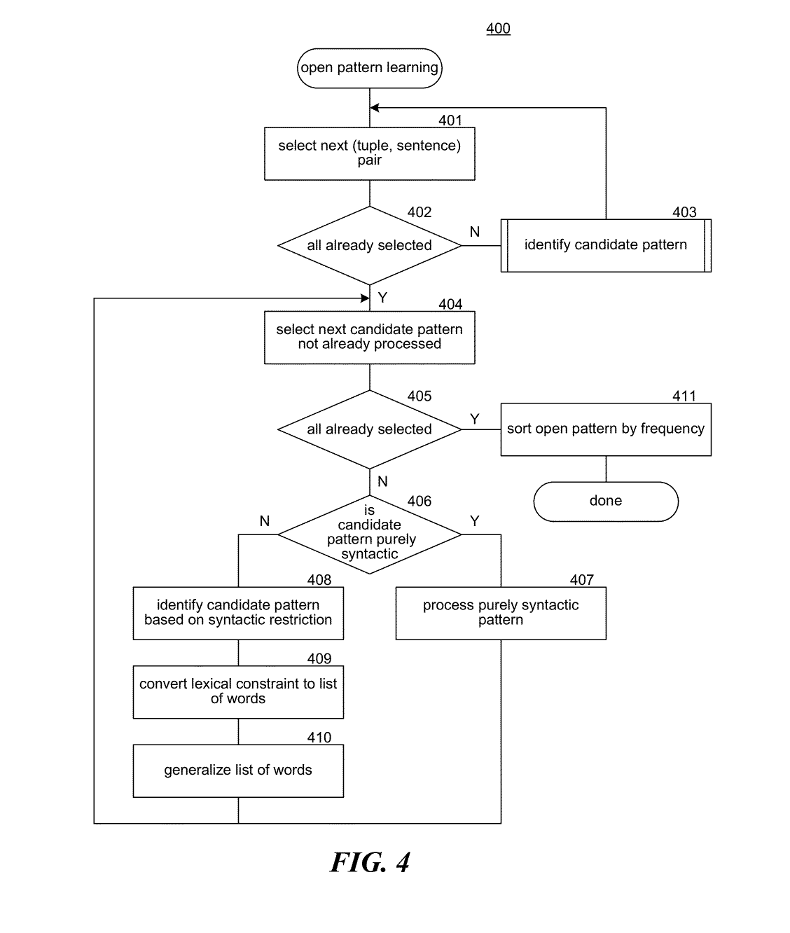

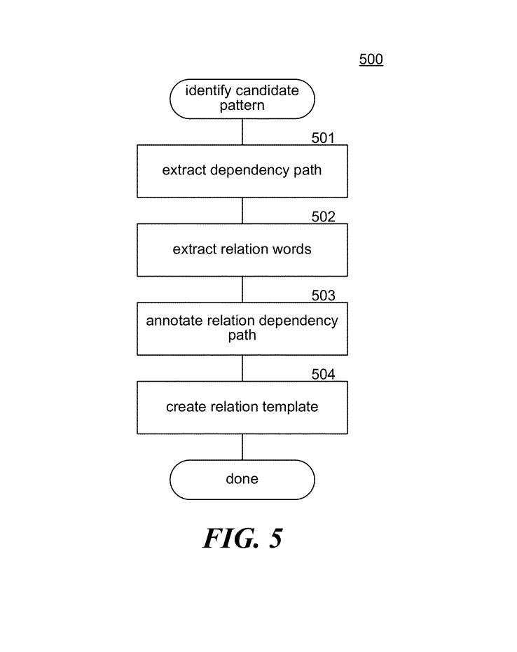

FIG. 4 illustrates open pattern learning, and FIG. 5 illustrates identifying candidate patterns. OLLIE'S next step is to learn general patterns that encode various ways of expressing relations. OLLIE learns open pattern templates—a mapping from a dependency path to an open extraction, i.e., one that identifies both the arguments and the exact (REVERB-style) relation phrase. Table 2 gives examples of high-frequency pattern templates learned by OLLIE. Note that some of the dependency paths are completely unlexicalized (#1-3), whereas in other cases some nodes have lexical or semantic restrictions (#4, 5).

Open pattern templates encode the ways in which a relation (in the first column) may be expressed in a sentence (second column). For example, a relation (Godse; kill; Gandhi) may be expressed with a dependency path (#2) {Godse}↑nsubj↑{kill:postag=VBD}↓dobj↓{Gandhi}.

To learn the pattern templates, we first extract the dependency path connecting the arguments (501) and relation words (502) for each seed tuple and the associated sentence (401-403). We annotate the relation node in the path with the exact relation word (as a lexical constraint) and the POS (postag constraint) (503). We create a relation template from the seed tuple by normalizing ‘is’/‘was’/‘will be’ to ‘be’, and replacing the relation content word with {rel} (504). (Note: Our current implementation only allows a single relation content word; extending to multiple words is straightforward—the templates will require rel1, rel2, . . . )

If the dependency path has a node that is not part of the seed tuple, we call it a slot node. Intuitively, if slot words do not negate the tuple they can be skipped over. As an example, ‘hired’ is a slot word for the tuple (Annacone; is the coach of; Federer) in the sentence “Federer hired Annacone as a coach”. We associate postag and lexical constraints with the slot node as well. (see #5 in Table 2).

Next, we perform several syntactic checks on each candidate pattern (404-406). These checks are the constraints that we found to hold in very general patterns, which we can safely generalize to other unseen relations. The checks are: (1) There are no slot nodes in the path. (2) The relation node is in the middle of arg1 and arg2. (3) The preposition edge (if any) in the pattern matches the preposition in the relation. (4) The path has no nn or amod edges.

If the checks hold true we accept it as a purely syntactic pattern with no lexical constraints. Others are semantic/lexical patterns and require further constraints to be reliable as extraction patterns.

TABLE 2

| Extraction Template | Open Pattern |
|---|---|
| 1. (arg1; be {rel} {prep}; arg2) | {arg1} ↑nsubjpass↑ {rel:postag=VBN} ↓{prep_*}↓ {arg2} |
| 2. (arg1; {rel}; arg2) | {arg1} ↑nsubj↑ {rel:postag=VBD} ↓dobj,↓ {arg2} |
| 3. (arg1; be {rel} by; arg2) | {arg1} ↑nsubjpass↑ {rel:postag=VBN} ↓agent↓ {arg2} |
| 4. (arg1; be {rel} of; arg2) | {rel:postag=NN;type=Person} ↑nn↑ {arg1} ↓nn↓ {arg2} |
| 5. (arg1; be {rel} {prep}; arg2) | {arg1} ↑nsubjpass↑ {slot:postag=VBN;lex |
| | εannounce\|name\|choose...} ↓dobj↓ {rel:postag=NN} |
| | ↓{prep_*}↓ {arg2} |

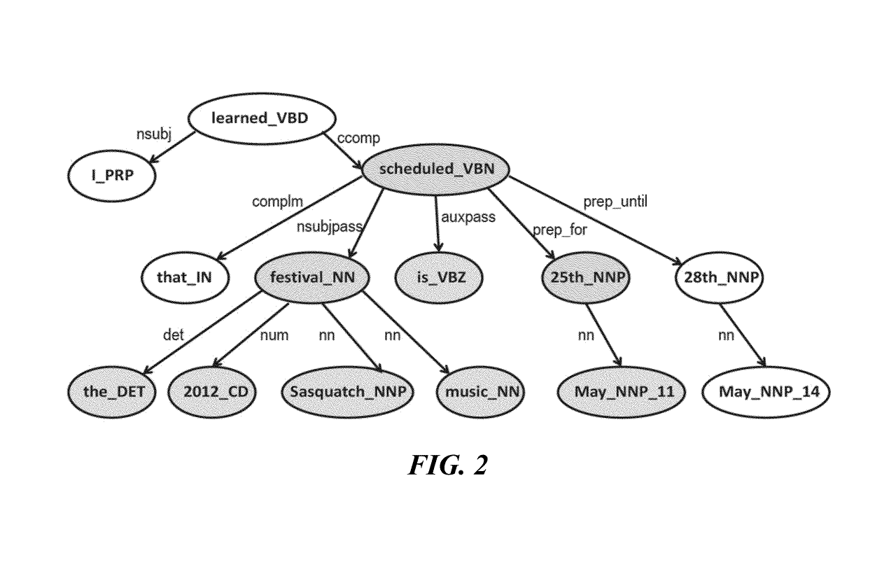

Table 2: Sample open pattern templates. Notice that some patterns (1-3) are purely syntactic, and others are semantic/lexically constrained (in bold font). A dependency parse that matches pattern #1 is shown in FIG. 2.

2.1 Purely Syntactic Patterns

For syntactic patterns, we aggressively generalize to unseen relations and prepositions (407). We remove all lexical restrictions from the relation nodes. We convert all preposition edges to an abstract {prep_*} edge. We also replace the specific prepositions in extraction templates with {prep}.

As an example, consider the sentences, “Michael Webb appeared on Oprah . . . ” and “ . . . when Alexander the Great advanced to Babylon.” and associated seed tuples (Michael Webb; appear on; Oprah) and (Alexander; advance to; Babylon). Both these data points return the same open pattern after generalization: “{arg1} ↑nsubj↓{rel:postag=VBD} ↓{prep_*}↓ {arg2}” with the extraction template (arg1, {rel} {prep}, arg2). Other examples of syntactic pattern templates are #1-3 in Table 2.

2.2 Semantic/Lexical Patterns

Patterns that do not satisfy the checks are not as general as those that do, but are still important. Constructions like “Microsoft co-founder Bill Gates . . . ” work for some relation words (e.g., founder, CEO, director, president, etc.) but would not work for other nouns; for instance, from “Chicago Symphony Orchestra” we should not conclude that (Orchestra; is the Symphony of; Chicago).

Similarly, we may conclude (Annacone; is the coach of; Federer) from the sentence “Federer hired Annacone as a coach.”, but this depends on the semantics of the slot word, ‘hired’. If we replaced ‘hired’ by ‘fired’ or ‘considered’ then the extraction would be false.

To enable such patterns we retain the lexical constraints on the relation words and slot words. (For highest precision extractions, we may also need semantic constraints on the arguments. In this work, we increase our yield by ignoring the argument-type constraints.) We collect all patterns together based only on the syntactic restrictions (408) and convert the lexical constraint into a list of words with which the pattern was seen (409). Example #5 in Table 2 shows one such lexical list.

Can we generalize these lexically-annotated patterns further? Our insight is that we can generalize a list of lexical items to other similar words (410). For example, if we see a list like {CEO, director, president, founder}, then we should be able to generalize to ‘chairman’ or ‘minister’.

Several ways to compute semantically similar words have been suggested in the literature like Wordnet-based, distributional similarity, etc. (e.g., (Resnik, 1996; Dagan et al., 1999; Ritter et al., 2010)). For our proof of concept, we use a simple overlap metric with two important Wordnet classes—Person and Location. We generalize to these types when our list has a high overlap (>75%) with hyponyms of these classes. If not, we simply retain the original lexical list without generalization. Example #4 in Table 2 is a type-generalized pattern.

We combine all syntactic and semantic patterns and sort in descending order based on frequency of occurrence in the training set (411). This imposes a natural ranking on the patterns—more frequent patterns are likely to give higher precision extractions.

### 3. PATTERN MATCHING FOR EXTRACTION (600)

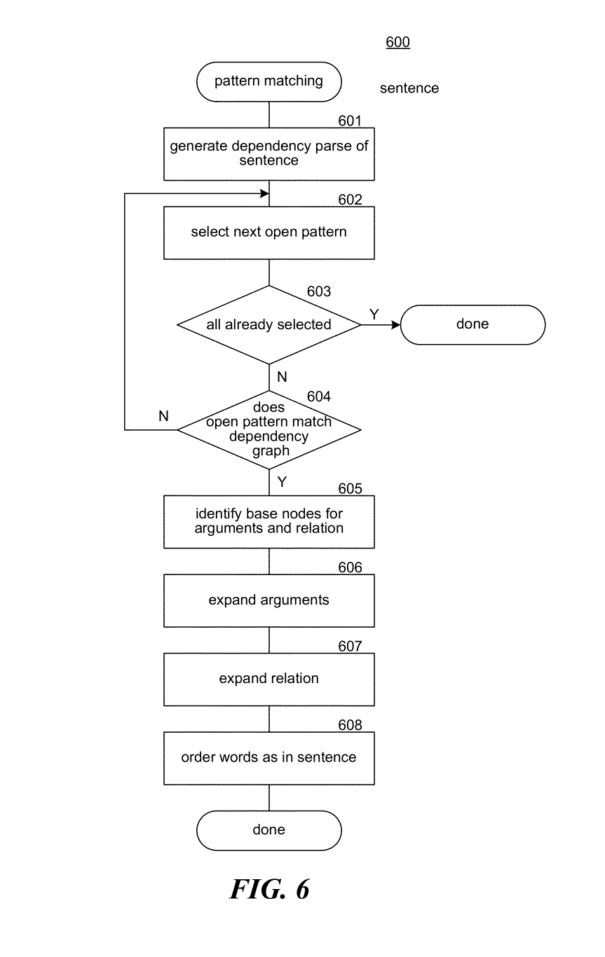

FIG. 6 illustrates pattern matching. We now describe how these open patterns are used to extract binary relations from a new sentence. We first match the open patterns with the dependency parse of the sentence (601-604) and identify the base nodes for arguments and relations (605). We then expand these to convey all the information relevant to the extraction.

As an example, consider the sentence: “I learned that the 2012 Sasquatch music festival is scheduled for May 25th until May 28th.” FIG. 4 illustrates the dependency parse. To apply pattern #1 from Table 2 we first match arg1 to ‘festival’, rel to ‘scheduled’ and arg2 to ‘25th’ with prep ‘for’. However, (festival, be scheduled for, 25th) is not a very meaningful extraction. We need to expand this further.

For the arguments we expand on amod, nn, det, neg, prep_of, num, quantmod edges to build the noun-phrase (606). When the base noun is not a proper noun, we also expand on rcmod, infmod, partmod, ref, prepc_of edges, since these are relative clauses that convey important information. For relation phrases, we expand on advmod, mod, aux, auxpass, cop, prt edges (607). We also include dobj and iobj in the case that they are not in an argument. After identifying the words in arg/relation we choose their order as in the original sentence (608). For example, these rules will result in the extraction (the Sasquatch music festival; be scheduled for; May 25th).

FIG. 2 is a sample dependency parse. The colored/greyed nodes represent all words that are extracted from the pattern {arg1} ↑nsubjpass↑ {rel:postag=VBN} ↓{prep_*}↓ {arg2}. The extraction is (the 2012 Sasquatch Music Festival; is scheduled for; May 25th).

### 4. CONTEXT ANALYSIS IN OLLIE (700)

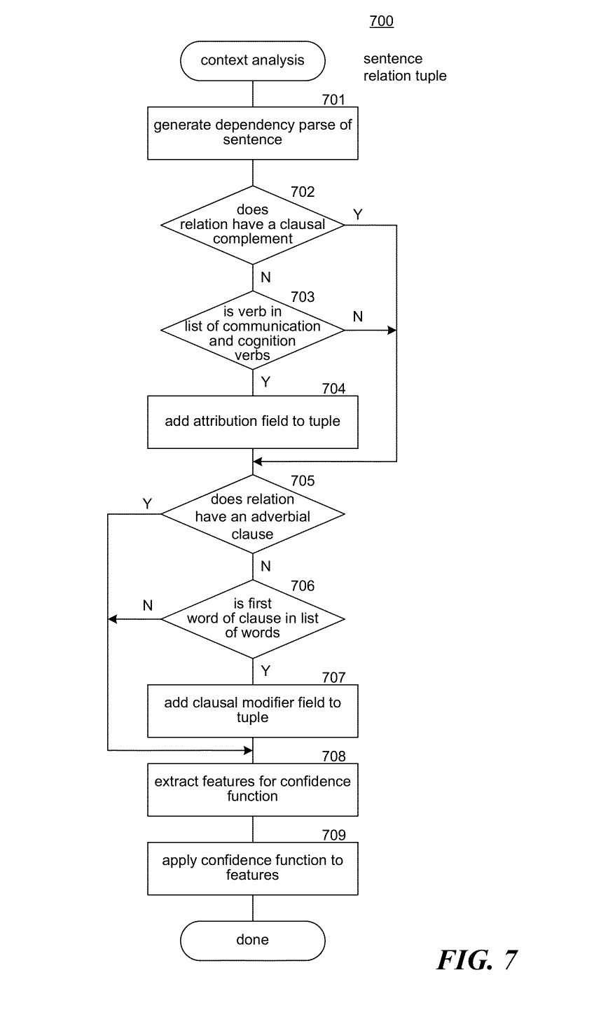

FIG. 7 illustrates context analysis. We now turn to the context analysis component, which handles the problem of extractions that are not asserted as factual in the text. In some cases, OLLIE can handle this by extending the tuple representation with an extra field that turns an otherwise incorrect tuple into a correct one. In other cases, there is no reliable way to salvage the extraction, and OLLIE can avoid an error by giving the tuple a low confidence.

Cases where OLLIE extends the tuple representation include conditional truth and attribution. Consider sentence #4 in Table 1. It is not asserting that the earth is the center of the universe. OLLIE adds an AttributedTo field, which makes the final extraction valid (see OLLIE extraction in Table 1). This field indicates who said, suggested, believes, hopes, or doubts the information in the main extraction.

Another case is when the extraction is only conditionally true. Sentence #5 in Table 1 does not assert as factual that (Romney; will be elected; President), so it is an incorrect extraction. However, adding a condition (“if he wins five states”) can turn this into a correct extraction. We extend OLLIE to have a ClausalModifier field when there is a dependent clause that modifies the main extraction.

Our approach for extracting these additional fields makes use of the dependency parse structure (701). We find that attributions are marked by a ccomp (clausal complement) edge. For example, in the parse of sentence #4 there is a ccomp edge between ‘believe’ and ‘center’. Our algorithm first checks for the presence of a ccomp edge to the relation node (702). However, not all ccomp edges are attributions. We match the context verb (e.g., ‘believe’) with a list of communication and cognition verbs from VerbNet (Schuler, 2006) to detect attributions (703). The context verb and its subject then populate the AttributedTo field (704).

Similarly, the clausal modifiers are marked by advcl (adverbial clause) edge (705). We filter these lexically, and add a ClausalModifier field when the first word of the clause matches a list of 16 terms created using a training set: {if, when, although, because, . . . } (706-707).

OLLIE has high precision for AttributedTo and ClausalModifier fields, nearly 98% on a development set, however, these two fields do not cover all the cases where an extraction is not asserted as factual. To handle others, we train OLLIE'S confidence function to reduce the confidence of an extraction if its context indicates it is likely to be non-factual.

We use a supervised logistic regression classifier for the confidence function (709). Features include the frequency of the extraction pattern, the presence of AttributedTo or ClausalModifier fields, and the position of certain words in the extraction's context, such as function words or the communication and cognition verbs used for the AttributedTo field (708). For example, one highly predictive feature tests whether or not the word ‘if’ comes before the extraction when no ClausalModifier fields are attached. Our training set was 1000 extractions drawn evenly from Wikipedia, News, and Biology sentences.

### 5. REFERENCES

ARPA. 1991. Proc. 3rd Message Understanding Conf. Morgan Kaufmann.
ARPA. 1998. Proc. 7th Message Understanding Conf. Morgan Kaufmann.
M. Banko, M. Cafarella, S. Soderland, M. Broadhead, and O. Etzioni. 2007. Open information extraction from the Web. In Procs. of IJCAI.
Andrew Carlson, Justin Betteridge, Bryan Kisiel, Burr Settles, Estevam R. Hruschka Jr., and Tom M. Mitchell. 2010. Toward an architecture for never-ending language learning. In Procs. of AAAI.
Ido Dagan, Lillian Lee, and Fernando C. N. Pereira. 1999. Similarity-based models of word cooccurrence probabilities. Machine Learning, 34(1-3):43-69.
Marie-Catherine de Marneffe, Bill MacCartney, and Christopher D. Manning. 2006. Generating typed dependency parses from phrase structure parses. In Language Resources and Evaluation (LREC 2006).
Oren Etzioni, Anthony Fader, Janara Christensen, Stephen Soderland, and Mausam. 2011. Open information extraction: the second generation. In Proceedings of the International Joint Conference on Artificial Intelligence (IJCAI '11).
Anthony Fader, Stephen Soderland, and Oren Etzioni. 2011. Identifying relations for open information extraction. In Proceedings of EMNLP.
Raphael Hoffmann, Congle Zhang, and Daniel S. Weld. 2010. Learning 5000 relational extractors. In Proceedings of the 48th Annual Meeting of the Association for Computational Linguistics, ACL '10, pages 286-295.
Raphael Hoffmann, Congle Zhang, Xiao Ling, Luke S. Zettlemoyer, and Daniel S. Weld. 2011. Knowledge-based weak supervision for information extraction of overlapping relations. In ACL, pages 541-550.
Mike Mintz, Steven Bills, Rion Snow, and Dan Jurafsky. 2009. Distant supervision for relation extraction without labeled data. In ACL-IJCNLP '09: Proceedings of the Joint Conference of the 47th Annual Meeting of the ACL and the 4th International Joint Conference on Natural Language Processing of the AFNLP: Volume 2, pages 1003-1011.
Joakim Nivre and Jens Nilsson. 2004. Memory-based dependency parsing. In Proceedings of the Conference on Natural Language Learning (CoNLL-04), pages 49-56.
P. Resnik. 1996. Selectional constraints: an information-theoretic model and its computational realization. Cognition.
Sebastian Riedel, Limin Yao, and Andrew McCallum. 2010. Modeling relations and their mentions without labeled text. In ECML/PKDD (3), pages 148-163.
Alan Ritter, Mausam, and Oren Etzioni. 2010. A latent dirichlet allocation method for selectional preferences. In Proceedings of the 48th Annual Meeting of the Association for Computational Linguistics (ACL '10).
Karin Kipper Schuler. 2006. VerbNet: A Broad-Coverage, Comprehensive Verb Lexicon. Ph.D. thesis, University of Pennsylvania.
Fei Wu and Daniel S. Weld. 2010. Open information extraction using Wikipedia. In Proceedings of the 48th Annual Meeting of the Association for Computational Linguistics (ACL '10).

From the foregoing, it will be appreciated that specific embodiments of the invention have been described herein for purposes of illustration, but that various modifications may be made without deviating from the scope of the invention. Accordingly, the invention is not limited except as by the appended claims.

I/We claim:

1. A method for learning open patterns within a corpus of text, the method comprising:
providing seed tuples and associated sentences, the seed tuples having arguments and relations, each argument and relation having one or more words;
for each seed tuple and associated sentence,
creating a candidate pattern by:
extracting a dependency path of the sentence connecting the words of the arguments and the relation of the seed tuple, the dependency path having a relation node; and
annotating the relation node with the word of the relation and a part-of-speech constraint; and
replacing the relation word of the seed tuple with a relation symbol to create an extraction template;
when a candidate pattern is a syntactic pattern, generalizing the candidate pattern to unseen relations and preposition to generate an open pattern; and
when a candidate pattern is not a syntactic pattern,
collecting candidate patterns based on syntactic restrictions on the relation word; and
converting lexical constraints of the collected candidate patterns into a list of words of sentences with the candidate pattern to generate an open pattern.

2. The method of claim 1 wherein the creating of an extraction template includes normalizing verbs to “be”.

3. The method of claim 1 when a candidate pattern is not a syntactic pattern, generalizing the list of word to other similar words.

4. The method of claim 1 including sorting the open patterns based on frequency of occurrence in the sentences and matching the open patterns as sorted to a sentence.

5. The method of claim 1 including extracting a relational tuple from a sentence by:
matching an open pattern with a dependency parse of a sentence;
identifying base nodes of the dependency parse for the arguments and the relation of the extraction template of the matching open pattern; and
expanding the arguments and the relation to include information relevant to the extraction to form the relational tuple based on the extraction template.

6. The method of claim 5 including performing context analysis to handle extractions that are not asserted as factual in a sentence.

7. The method of claim 6 wherein performing context analysis includes adding an attribution field to the relational tuple to indicate who is asserting the relation.

8. The method of claim 6 wherein performing context analysis includes adding a clausal modifier field to the relational tuple when truth of the relation is conditional.

9. A system for extracting relational tuples from sentences, the relational tuples having arguments and relations, the system comprising:
a bootstrapper that generates training data by, for each of a plurality of seed tuples, identifying sentences of a corpus that contains the words of the seed tuple such that the seed tuple and an identified sentence form a seed tuple and sentence pair;
an open pattern learner that learns, from the seed tuples and sentence pairs, open patterns that encode ways in which relational tuples may be expressed in a sentence; and
a pattern matcher that matches the open patterns to a dependency parse of a sentence, identifies base nodes of the dependency parse for the arguments and relation for the relational tuple that the open pattern encodes, and expands the arguments and relation of the relational tuple.

10. The system of claim 9 wherein open pattern learner creates a candidate pattern by:
for each seed tuple and sentence pair,
extracting a dependency path of the sentence connecting the words of the arguments and the relation of the seed tuple, the dependency path having a relation node; and
annotating the relation node with the word of the relation and a part-of-speech constraint; and
when a candidate pattern is a syntactic pattern, generalizing the candidate pattern to unseen relations and preposition to generate an open pattern; and
when a candidate pattern is not a syntactic pattern,
collecting candidate patterns based on syntactic restrictions on the relation word; and
converting lexical constraints of the collected candidate patterns into a list of words of sentences with the candidate pattern to generate an open pattern.

11. The system of claim 10 wherein the open pattern learner further replaces the relation word of the seed tuple with a relation symbol to create an extraction template.

12. The system of claim 11 wherein the open pattern learner further normalize verbs to “be” in an extraction template.

13. The system of claim 9 including a context analyzer that adds an attribution field to the relational tuple to indicate who is asserting the relation and adds a clausal modifier field to the relational tuple when truth of the relation is conditional.

14. A method for learning open patterns within a corpus of text, the method comprising:
for seed tuple and sentence pairs, creating a candidate pattern by:
extracting a dependency path of the sentence connecting the words of the arguments and the relation of the seed tuple; and
annotating dependency path with the word of the relation and a part-of-speech constraint; and
when a candidate pattern is a syntactic pattern, generalizing the candidate pattern to unseen relations and preposition to generate an open pattern; and
when a candidate pattern is not a syntactic pattern, converting lexical constraints of the candidate patterns with similar syntactic restrictions on the relation word into a list of words of sentences with the candidate pattern to generate an open pattern.

15. The method of claim 14 including extracting a relational tuple from a sentence by:
matching an open pattern with a dependency parse of a sentence;
identifying base nodes of the dependency parse for the arguments and the relation of the extraction template of the matching open pattern; and
expanding the arguments and the relation to include information relevant to the extraction to form the relational tuple based on the extraction template.

16. The method of claim 15 including performing context analysis to handle extractions that are not asserted as factual in a sentence.

17. The method of claim 16 wherein performing context analysis includes adding an attribution field to the relational tuple to indicate who is asserting the relation.

18. The method of claim 16 wherein performing context analysis includes adding a clausal modifier field to the relational tuple when truth of the relation is conditional.

19. The method of claim 14 including replacing the relation word of the seed tuple with a relation symbol to create an extraction template.

20. The method of claim 19 including normalizing verbs to “be” in an extraction template.
